(19) United States
(12) Patent Application Publication
(10) Pub. No.: US 2024/0077354 A1
(43) Pub. Date: Mar. 7, 2024

(54) Aircraft Weight and Balance Calculator

(71) Applicant: Textron Aviation Inc., Wichita, KS (US)

(72) Inventors: Joseph Alfred Burch, II, Wichita, KS (US); Shane Anthony Harden, Wichita, KS (US); Jeffrey Lane Harden, Wichita, KS (US); Arthur Robert Below, Jr., Derby, KS (US); Benjamin Louis Martin, Augusta, KS (US)

(21) Appl. No.: 18/458,474

(22) Filed: Aug. 30, 2023

Related U.S. Application Data
(60) Provisional application No. 63/374,279, filed on Sep. 1, 2022.

(51) Int. Cl. G01G 23/37; G01G 19/07; G01M 1/12

(52) U.S. Cl. CPC G01G 23/3721; G01G 19/07; G01M 1/125

(57) ABSTRACT

An aircraft weight and balance system includes a user interface that displays an interior layout of an aircraft with seat icons and cargo icons corresponding to seats and cargo zones onboard the aircraft. The seat and cargo icons are moveable to different locations within the interior layout, and an updated weight and center-of-gravity of the aircraft is automatically determined based on the different locations of the seat and cargo icons. An aircraft weight and balance method includes displaying an interior layout of an aircraft on a user interface including seat icons corresponding to seats onboard the aircraft, moving one or more of the seat icons to a different location within the interior layout based on a user input, determining an updated weight and center-of-gravity of the aircraft based on a current location of the seat icons, and displaying the updated weight and center-of-gravity of the aircraft on the user interface.

### CROSS-REFERENCE TO RELATED APPLICATIONS

This application claims the benefit of priority of U.S. Provisional Patent Application No. 63/374,279, entitled Aircraft Weight and Balance Calculator and filed on Sep. 1, 2022, the disclosure of which is herein incorporated by reference in its entirety.

### BACKGROUND

### 1. Field of the Disclosure

Embodiments of this disclosure relate generally to aircraft operation, and more specifically to a software product and user interface configured for preflight calculations of aircraft weight and balance.

### 2. Description of the Related Art

Many weight and balance calculators have been described in the prior art. For example, U.S. Pat. No. 8,068,975 to Jensen et al. and U.S. Pat. No. 6,923,375 to Stefani describe automated systems for calculating the weight and balance of aircraft based on passenger and luggage data. U.S. Pat. No. 6,275,769 to Willis discloses a handheld device used for calculating the weight and balance measurements of an aircraft based on user input. The mobile software applications, Foreflight Mobile and Aircraft Performance Group (APG) iPreFlight provide a user with weight and balance calculations and adjustable floor plans. None of these references disclose improvements to weight and balance software disclosed herein.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, an aircraft weight and balance system includes: a controller having a memory for storing software and a processor for executing instructions of the software; a user interface communicatively coupled with the controller, the user interface including: a configuration page that displays an interior layout of an aircraft, the interior layout having a plurality of seat icons corresponding to a plurality of seats onboard an aircraft, wherein the user interface is configured to enable a user to move each of the seat icons to different locations within the interior layout; and the controller is configured to automatically determine an updated weight and center-of-gravity of the aircraft based on the different locations of the seat icons.

In an embodiment, an aircraft weight and balance method, including: displaying an interior layout of an aircraft on a user interface communicatively coupled with a controller, wherein the interior layout includes a plurality of seat icons corresponding to a plurality of seats onboard an aircraft; moving one or more of the seat icons to a different location within the interior layout based on a user input; determining, automatically via the controller, an updated aircraft weight and an updated aircraft center-of-gravity based on a current location of the seat icons; and displaying the updated aircraft weight and the updated aircraft center-of-gravity on the user interface.

### BRIEF DESCRIPTION OF THE DRAWINGS

Illustrative embodiments of the present disclosure are described in detail below with reference to the attached drawing figures, which are incorporated by reference herein and wherein:

FIG. 1 shows a user interface for an aircraft weight and balance calculator, in an embodiment;

FIG. 2 shows an embodiment of a configuration page of the user interface of FIG. 1;

FIG. 3 shows an embodiment of a historical configurations list of the user interface of FIG. 1;

FIG. 4 shows an embodiment of the configuration page of FIG. 2;

FIG. 5 shows another embodiment of the configuration page of FIG. 2;

FIG. 6 shows another embodiment of the configuration page of FIG. 2;

FIG. 7 shows another embodiment of the configuration page of FIG. 2;

FIG. 8 shows another embodiment of the configuration page of FIG. 2;

FIG. 9 shows another embodiment of the configuration page of FIG. 2;

FIG. 10 shows another embodiment of the configuration page of FIG. 2;

FIG. 11 shows another embodiment of the configuration page of FIG. 2;

FIG. 12 shows an embodiment of a mission page and an embodiment of a passenger weight page of the user interface of FIG. 1;

FIG. 13 shows an embodiment of a previous passenger list of the user interface of FIG. 1;

FIG. 14 shows an embodiment of a pilot weight page of the user interface of FIG. 1;

FIG. 15 shows an embodiment of a cargo weight page of the user interface of FIG. 1;

FIG. 16 shows an embodiment of a Unit Load Device (ULD) weight page of the user interface of FIG. 1; and

FIG. 17 shows an embodiment of a graph page of the user interface of FIG. 1.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments disclosed herein provide a software program that simplifies the process of calculating weight and balance measurements of an aircraft before flight. Additionally, embodiments provide functionality for a user to easily rearrange aircraft seating with a user interface that displays the aircraft interior while automatically updating the weight and balance measurements based on the planned seating changes. Also, cargo zone icons are provided on the user interface that enable a user to easily rearrange interior cargo zones or large objects that take up multiple loading zones, as well as Unit Load Device (ULD) loadings.

In embodiments, the user interface provides functionality to drag and drop seats and storage zones anywhere within the cabin to update a planned seating and cargo configuration. The software program automatically recalculates and provides entries for a continuous history database with a new aircraft Basic Empty Weight (BEW) and center of gravity (CG). In embodiments, all floor rail positions within the aircraft are configured for seating or cargo, which allows adjustments to seating and cargo plans quickly and easily from e.g., no passengers with cargo only, to all passengers without cargo, to anywhere in between. Special missions may be easily accommodated with a complete reconfiguration, or a slight change to a seating plan may be accomplished to provide added legroom or extra baggage stores.

In embodiments, a user may switch a cargo layout to accommodate various shipping container sizes of ULDs, or to accommodate bulk storage, or extra-large containers (e.g., a footprint of 65-inch by 85-inch). Additionally, embodiments feature adjustable storage CG for larger items which may extend across multiple loading zones (e.g., motorcycles or snow mobiles).

Embodiments disclosed herein include software programs carried out on a controller. The controller is communicatively coupled with a user interface, such as user interface 100 described below. The controller is for example a computer, microcontroller, microprocessor, or the like having a memory, including a non-transitory medium for storing software, and a processor for executing instructions of software. Memory may be used to store information and instructions of software. The software instructions may include but are not limited to algorithms, lookup tables, and models. For example, controller may store instructions in memory for customizing an interior aircraft configuration for a type of mission, or to accommodate personal information of individual users, which may then be reused on subsequent flights. Controller may be embodied in one or more printed circuit boards (PCBs) and/or integrated circuits (ICs). Controller is not limited by the materials from which it is formed or the processing mechanisms employed therein and, as such, may be implemented via semiconductor(s) and/or transistors (e.g., electronic integrated circuits (ICs)), etc.

A user interface is provided for a user to receive information and input instructions for manipulating aircraft interior layouts and for inputting and receiving information regarding weight and positioning of seats, passengers, and cargo. In embodiments, the user interface includes a touch screen for displaying information and receiving touch inputs by the user. Additionally, a keyboard and/or mouse may be used to provide user input. The user interface is operatively coupled with the processor for performing operations based on the user input, among other things.

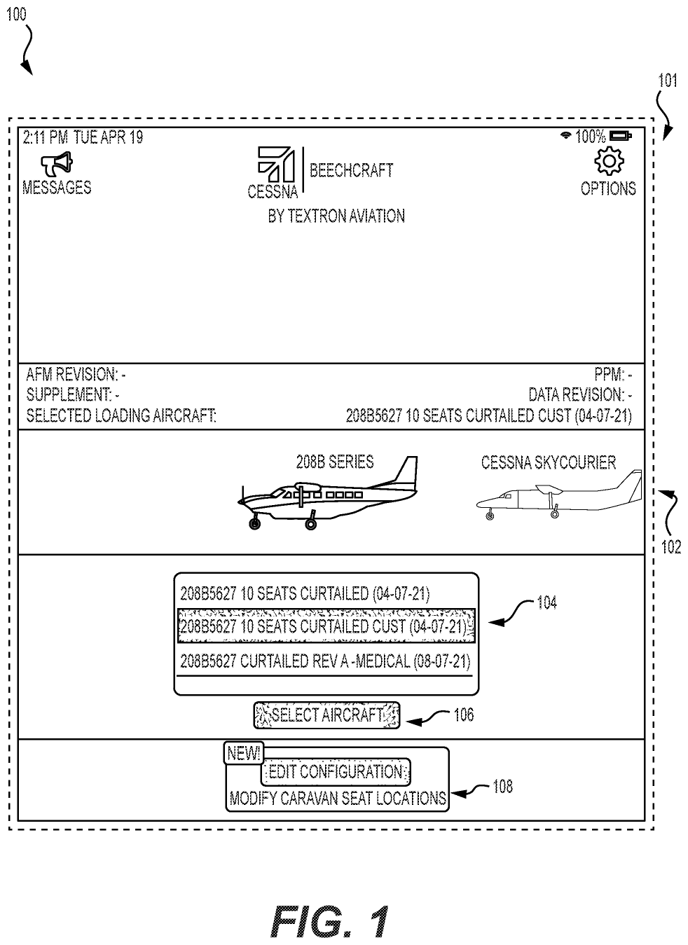

FIG. 1 shows an exemplary user interface 100 for an aircraft weight and balance calculator. The FIG. 1 view shows a home page for the aircraft weight and balance calculator in which a user begins the process of selecting features and their arrangements that affect the weight and balance (e.g., center of gravity) of a particular aircraft. In embodiments, user interface 100 includes an options button 101, an aircraft selector 102, a configuration list 104, a select aircraft button 106, and an optional edit configuration button 108. The buttons, selectors, and lists displayed on user interface 100 may be manipulated by a user via touch input for a touchscreen embodiment or via a keyboard (e.g., via keyboard shortcuts) and/or a mouse (e.g., by moving a cursor over a selection and clicking the mouse).

A layout of the various features displayed within user interface 100 may be rearranged without departing from the scope hereof. For example, options button 101 may provide lists of options for a user to rearrange features of user interface 100. Other features of user interface 100 may be adjusted via options provided via options button 101 such as units (e.g., metric vs. U.S. customary).

Aircraft selector 102 enables the user to scroll through a list of aircraft for which the aircraft weight and balance calculator is configured to operate and select the appropriate type or model of the aircraft. As depicted in FIG. 1, aircraft selector 102 may include both text and images of the various models of aircraft. Configuration list 104 shows a list of configurations specific to the model of aircraft selected via aircraft selector 102. Configuration list 104 is scrollable for enabling the user to browse the various configurations available. Once the appropriate type/model of aircraft and configuration are highlighted using aircraft selector 102 and configuration list 104, the user may confirm the selection via select aircraft button 106. Optionally, edit configuration button 108 is provided, which enables the user to edit configurations of aircraft and save new configuration descriptions to be displayed in configuration list 104.

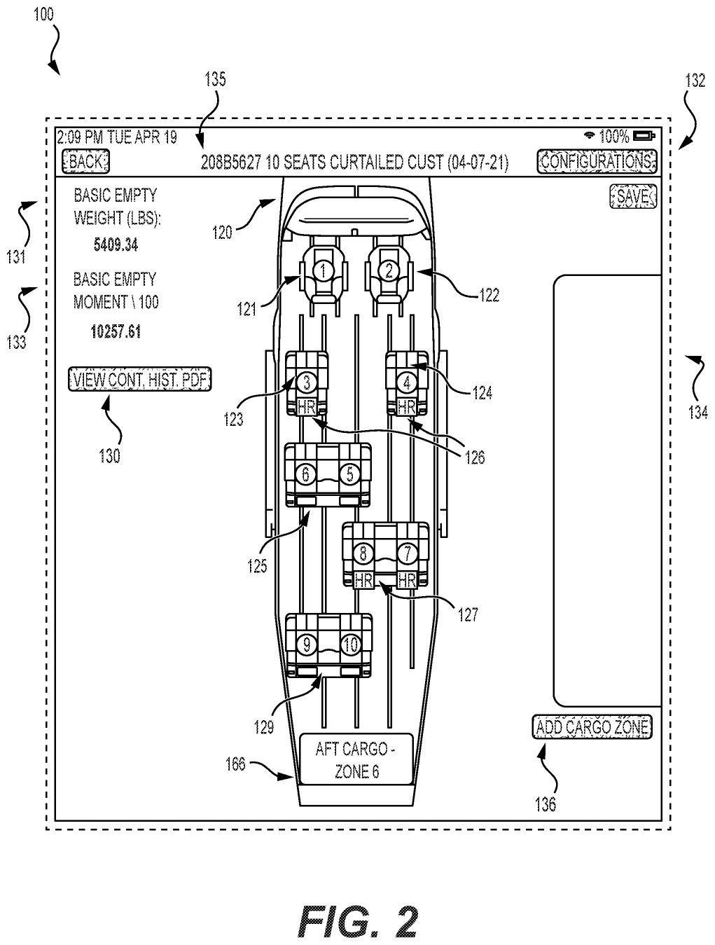

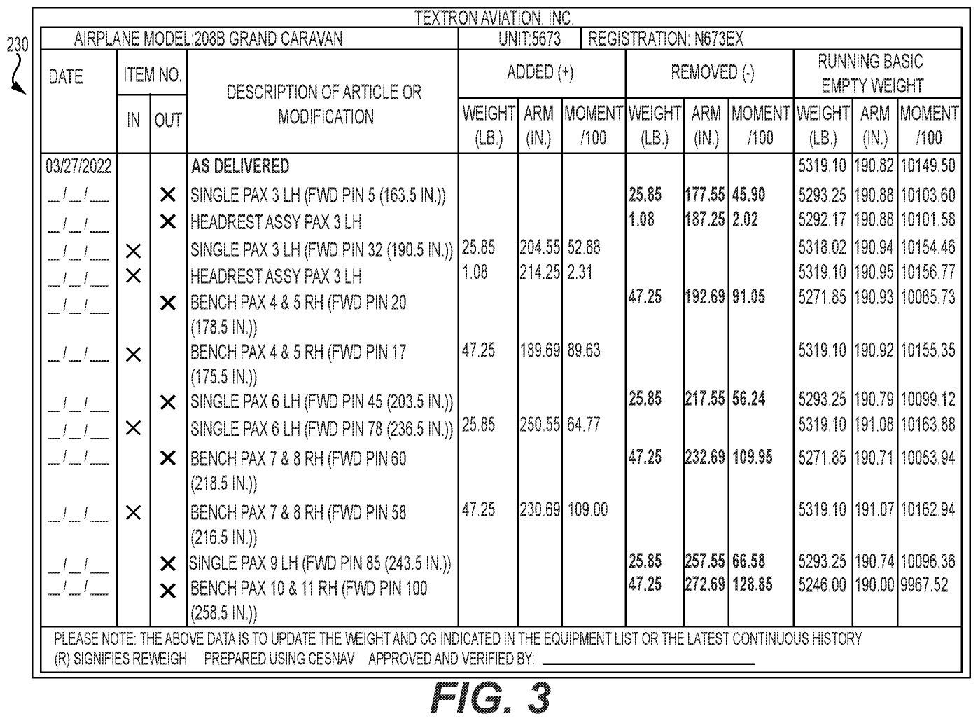

FIG. 2 shows user interface 100 for an aircraft weight and balance calculator on a configuration page 132. In embodiments, configuration page 132 is selected from the home page shown in FIG. 1 via the edit configuration button 108. A title 135 may be displayed for indicating which configuration is to be edited via configuration page 132. An interior layout 120 provides a top-down view of the aircraft cockpit and cabin floorplan including seats and cargo as further described below. A basic empty weight 131 and a basic empty moment 133 may be listed, both of which may update automatically upon changes being made to the arrangement of seats and cargo within interior layout 120. A continuous history button 130 opens a new page showing a list of the historical configurations of seating and cargo used previously for this aircraft model. The historical configurations list (see e.g., FIG. 3) is automatically updated when configuration page 132 is used to rearrange seating and cargo placements within interior layout 120 and the new configuration is saved.

FIG. 3 shows an exemplary historical configurations list 230. Historical configurations list 230 may list items (e.g., chairs, benches, cargo) that were added or removed and the date on which the changes were made. A weight, arm length, and moment of each item may also be listed for both added and removed items. The running basic empty weight, center-of-gravity and moment of the aircraft may also be listed corresponding to each of the added and removed items. Once updates are completed, the historical configurations list 230 may be signed and placed in an aircraft flight manual (AFM) to support the configuration changes.

Returning to FIG. 2, seating placements may be arranged by dragging and dropping seat icons. For example, a first chair 121 and a second chair 122 comprise icons for a pilot seat and a copilot seat respectively. A third chair 123 and a fourth chair 124 are examples of individual seats. A first bench 125 is for example a couch and includes a fifth seat and a sixth seat. Similarly, a second bench 127 includes a seventh seat and an eighth seat, and a third bench 129 includes a ninth seat and a tenth seat. Seats having headrests may include a headrest icon 126, as shown for third chair 123 and fourth chair 124. A sixth aft cargo zone 166 depicts a zone for storing cargo in an aft position of interior layout 120. An off-aircraft zone 134 provides a temporary location for storing icons while rearranging interior layout 120, as further described below. An add cargo zone button 136 enables the user to create additional cargo zones and enter information about a size of the cargo zone to be created, for example.

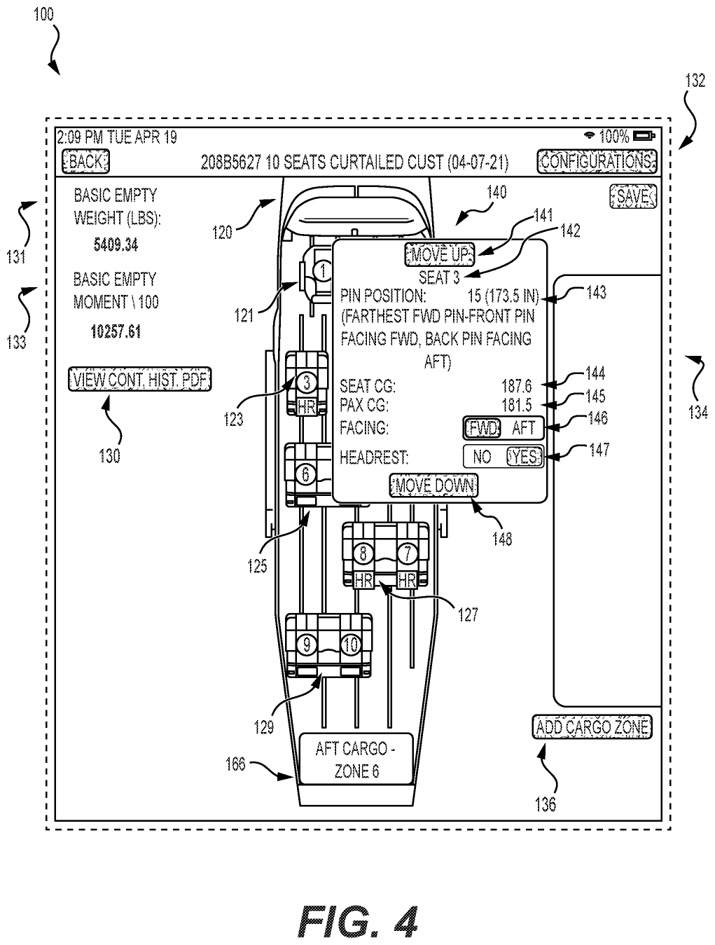

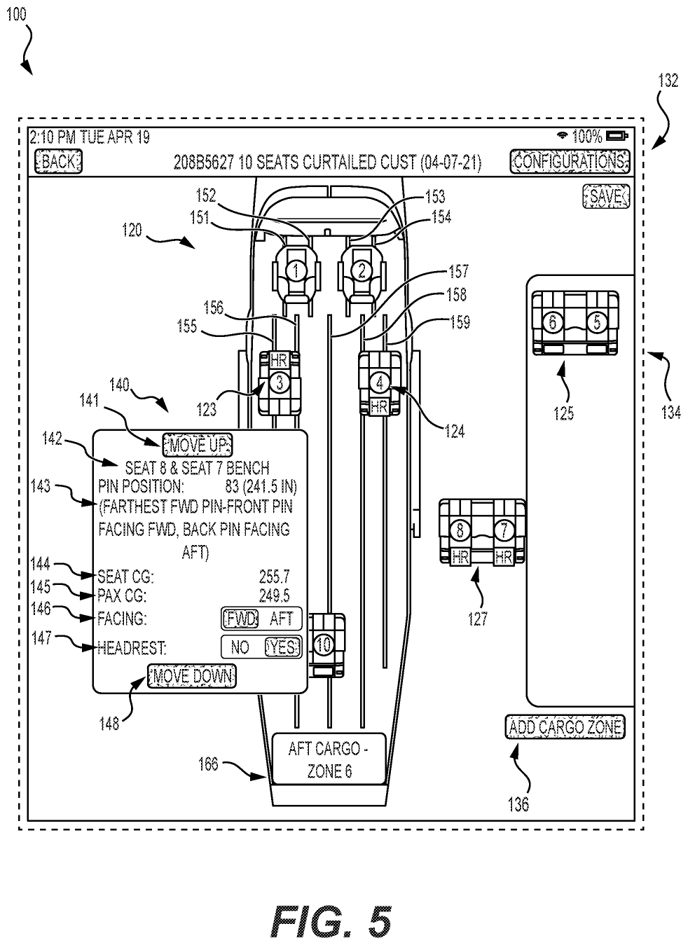

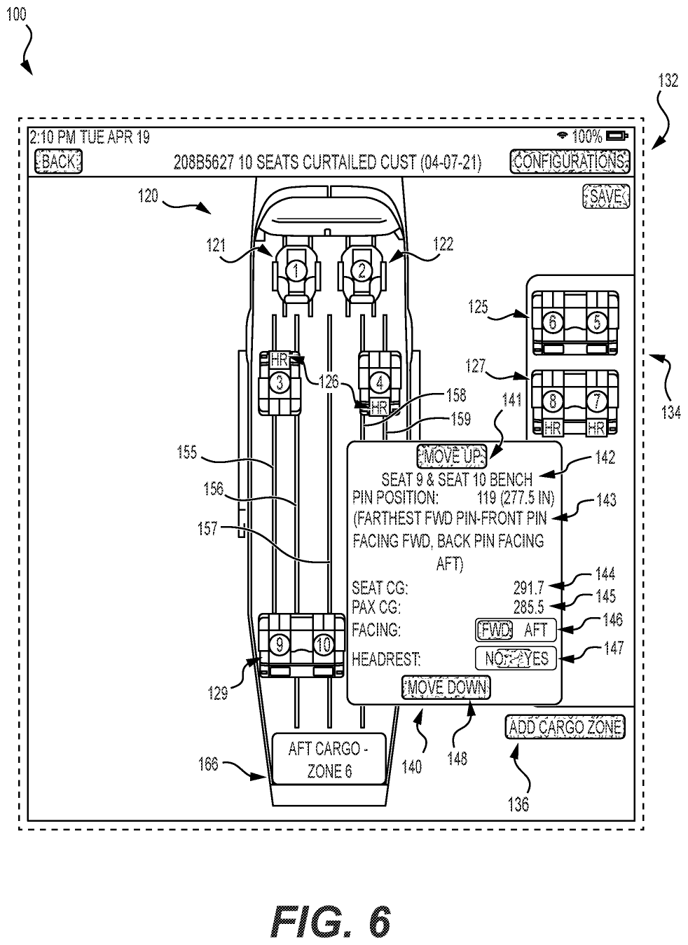

FIG. 4 shows configuration page 132 of user interface 100 with an exemplary move item window 140 configured for displaying positional information and receiving inputs for moving seats or cargo. Move item window 140 may be opened by selecting a chair, bench or cargo icon to be moved. The chair, bench or cargo icon may be moved forward or aft by dragging the icon, and information displayed in exemplary move item window 140 may automatically update in real time while the icon position is moving. In the embodiment shown in FIG. 5, a move up button 141 enables the user to move a seat or cargo towards the front of the aircraft, and a move down button 148 enables the user to move a seat or cargo towards the aft of the aircraft. A title 142 displays a name of the seat or cargo that is currently selected for moving. A position indicator 143 displays a position of the seat or cargo. For example, position indicator 143 may indicate a pin position of a particular pin used to secure the seat or cargo to a rail on the floor of the aircraft. A plurality of rails are depicted in interior layout 120 and are described below in connection with FIGS. 5 and 6.

Returning to FIG. 4, a seat center-of-gravity indicator 144 displays the current center-of-gravity position of the selected seat or cargo with respect to the aircraft datum. A passenger center-of-gravity indicator 145 displays the current center-of-gravity position of a passenger assigned to the seat. A directional switch 146 displays forward and aft options for a direction in which the seat is facing and highlights the presently selected direction. The user may switch the direction in which the seat is facing by clicking on or touching directional switch 146. Seat center-of-gravity indicator 144 and passenger center-of-gravity indicator 145 automatically update information when the seat direction is switched. A headrest indicator 147 displays an indication as to whether or not the seat includes a headrest, and the user may change the headrest configuration by clicking on or touching headrest indicator 147. In embodiments, only single seats may be oriented facing aft, and aft facing single seats are required to have a headrest when facing aft. The software instructions executed by the processor automatically implement the addition of a headrest to single aft facing seats when created via configuration page 132. Additionally, the software instructions prevent removal of a headrest from an aft facing single seat.

FIG. 5 shows configuration page 132 of user interface 100 with another exemplary move item window 140 configured for displaying positional information and receiving inputs for moving second bench 127. As depicted in FIG. 5, the icon for second bench 127 is actively being dragged from interior layout 120 to off-aircraft zone 134. First bench 125 has already been dragged into off-aircraft zone 134 for temporary storage compared with the FIG. 4 view. Icons moved to off-aircraft zone 134 may subsequently be returned to interior layout 120 or deleted from configuration page 132.

Icons representing a plurality of rails are enumerated in FIGS. 5 and 6. Specifically, a first rail 151 and a second rail 152 are depicted in a cockpit region of interior layout 120 for securing first chair 121. A third rail 153 and a fourth rail 154 are depicted in a cockpit region of interior layout 120 for securing second chair 122. First chair 121 and second chair 122, which are for example a pilot and copilot seat respectively, may be moved forward and aft longitudinally along their respective rails.

In a cabin portion of interior layout 120, icons representing a plurality of additional rails are provided on the floor of the cabin. A fifth rail 155 and a sixth rail 156 are configured for securing an individual seat such as third chair 123 in a plurality of positions. A seventh rail 157 is aligned longitudinally along a central region of interior layout 120 and is configured for securing benches and cargo together with neighboring rails. An eighth rail 158 and a ninth rail 159 are configured for securing an individual seat such as fourth chair 124 in a plurality of positions. In embodiments, benches 125, 127, and 129 may each be secured to three consecutive rails such as fifth rail 155, sixth rail 156, and seventh rail 157, or to seventh rail 157, eighth rail 158, and ninth rail 159. Cargo may be secured to two or more rails including all five rails depicted in the cabin portion of interior layout 120.

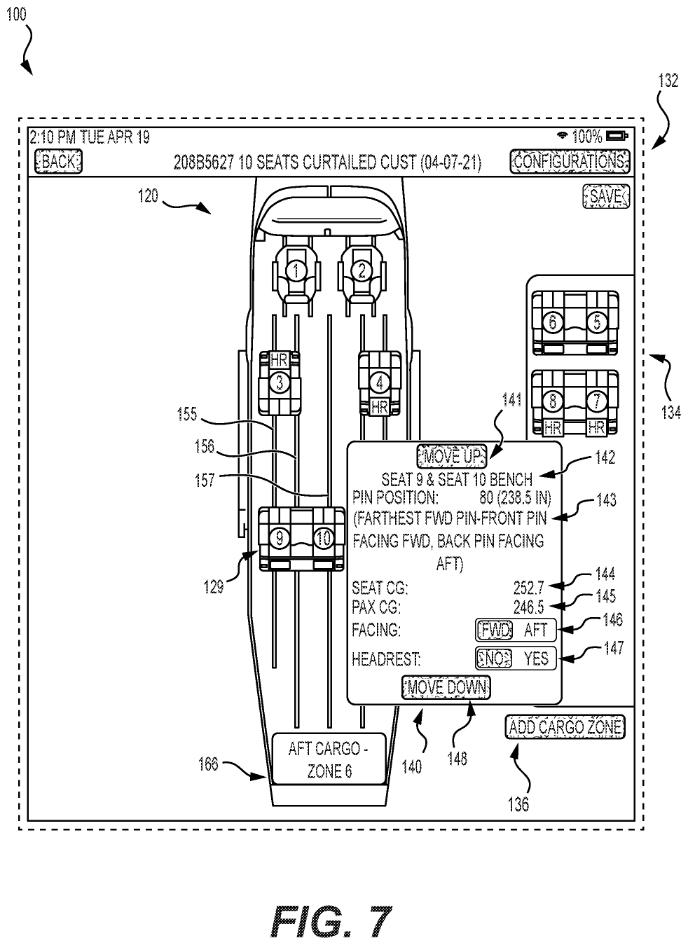

FIG. 6 and FIG. 7 show configuration page 132 of user interface 100 with another exemplary move item window 140 configured for displaying positional information and receiving inputs for moving third bench 129. In the view of FIG. 6 and FIG. 7, first bench 125 and second bench 127 have been moved to off-aircraft zone 134. Third bench may be moved longitudinally along fifth rail 155, sixth rail 156, and seventh rail 157 as shown in FIG. 6 and FIG. 7. Specifically, FIG. 6 shows third bench 129 in a more aft position compared to the position shown in FIG. 7. Position indicator 143, seat center-of-gravity indicator 144, and passenger center-of-gravity indicator 145 are all updated as third bench 129 is moved between the FIG. 6 position and the FIG. 7 position.

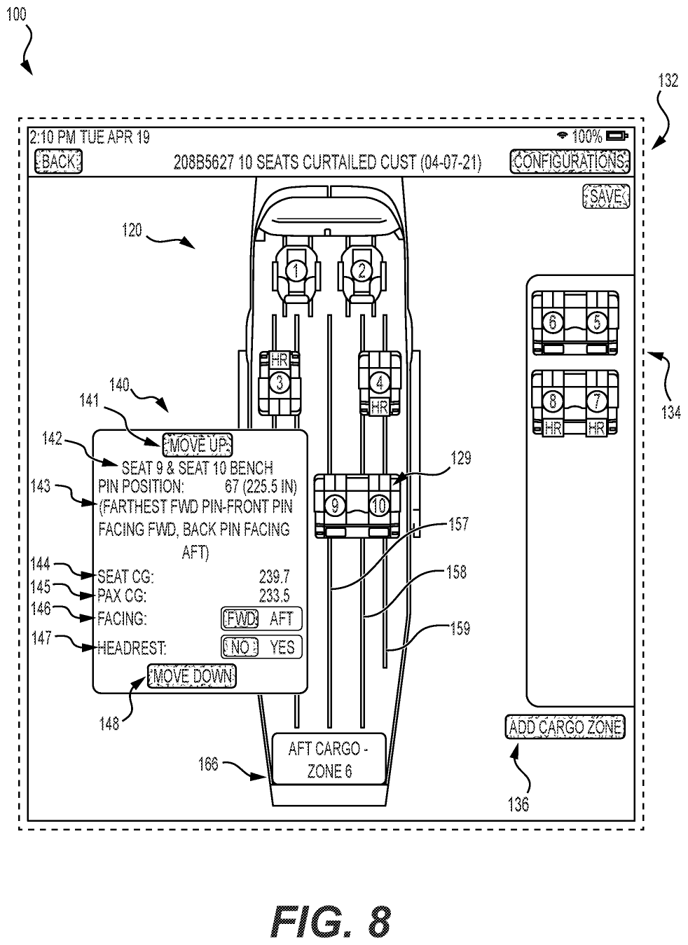

FIG. 8 shows configuration page 132 of user interface 100 with another exemplary move item window 140 configured for displaying positional information and receiving inputs for moving third bench 129. Compared to the FIG. 7 view, third bench 129 has been moved laterally across interior layout 120. Specifically, in the FIG. 7 view, third bench 129 is positioned over fifth rail 155, sixth rail 156, and seventh rail 157. In the FIG. 8 view, third bench 129 is positioned over seventh rail 157, eighth rail 158, and ninth rail 159. In embodiments, the floor rails within the cabin interior are configured for seats, benches, and cargo to be freely moved laterally across the cabin. As such, seats, benches, and cargo may be moved laterally across interior layout 120 along the rails 155-159 by dragging the appropriate icon.

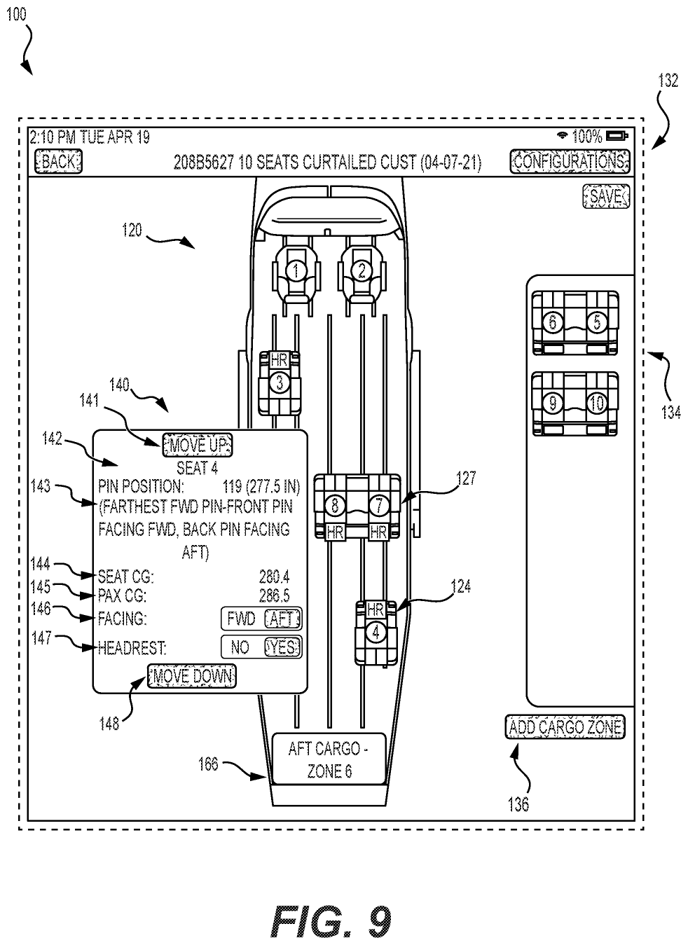

FIG. 9 shows configuration page 132 of user interface 100 with another exemplary move item window 140 configured for displaying positional information and receiving inputs for moving fourth chair 124. In the FIG. 9 view, fourth chair 124 has been moved aft of second bench 127. Due to the rails 155-159 extending continuously along the longitudinal direction of the aircraft cabin, positions of seats and benches may be easily swapped by dragging the appropriate icons into the desired locations. Meanwhile, the calculations for pin position, seat center-of-gravity, and passenger (PAX) center-of-gravity, are continually updated and displayed via position indicator 143, seat center-of-gravity indicator 144, and passenger center-of-gravity indicator 145, respectively.

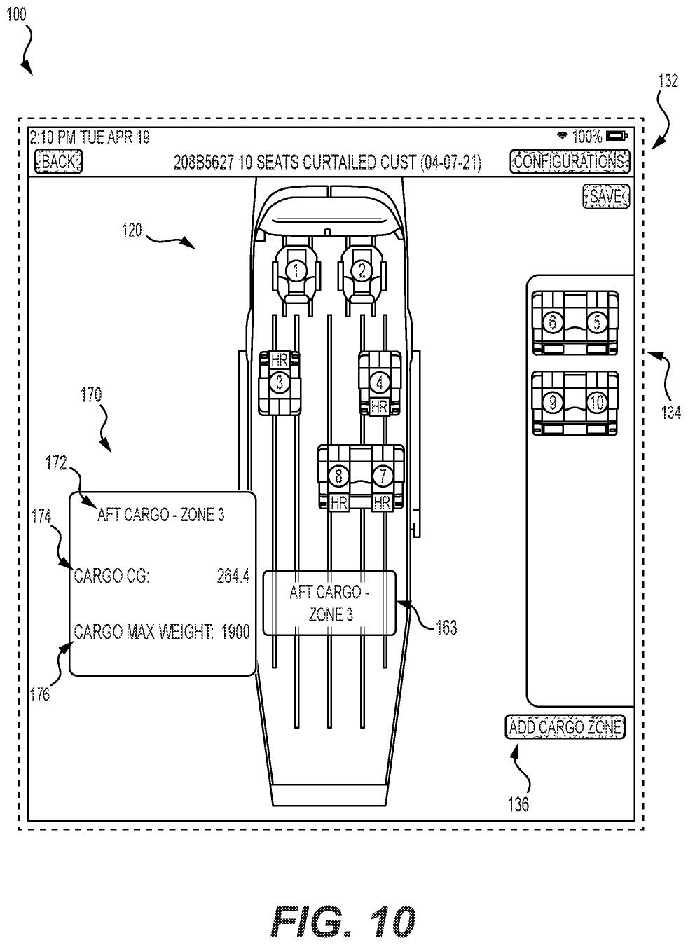

FIG. 10 shows configuration page 132 of user interface 100 with an exemplary move item window 170 configured for displaying positional information while moving a third cargo zone 163. Move item window 170 displays a title 172, a cargo center-of-gravity indicator 174, and a cargo maximum weight indicator 176. As the icon for third cargo zone 163 is moved longitudinally in the forward or aft direction, information is automatically updated for displaying via cargo center-of-gravity indicator 174 and cargo maximum weight indicator 176.

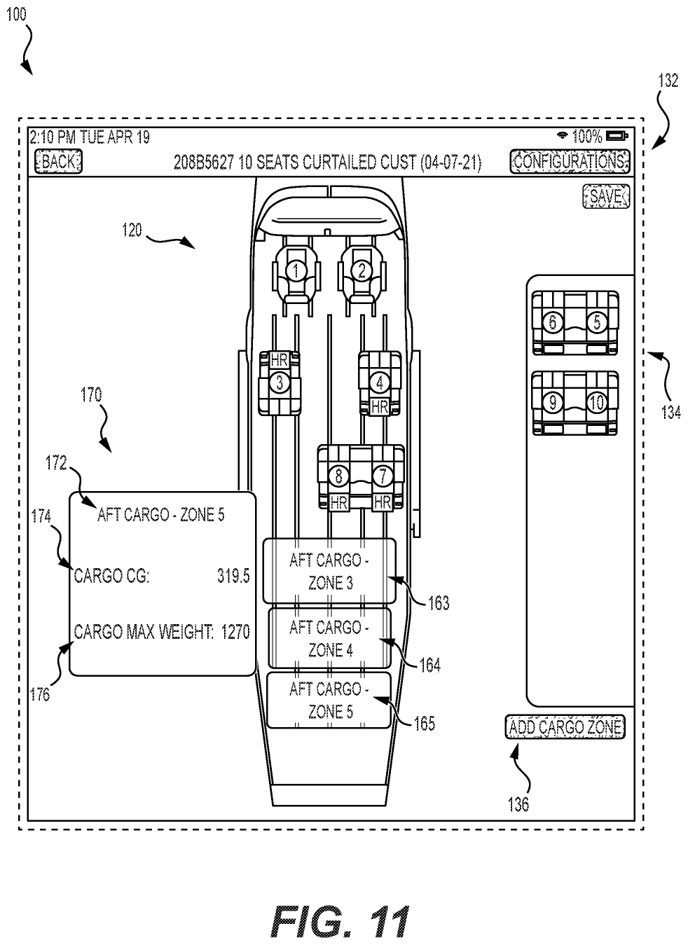

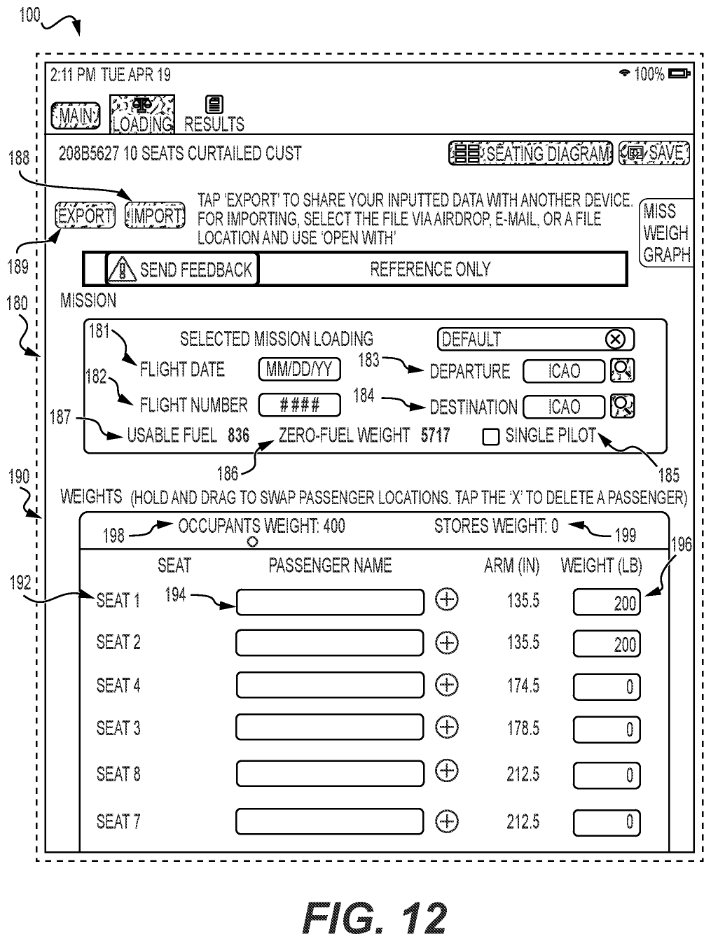

FIG. 11 shows configuration page 132 of user interface 100 with a move item window 170 configured for displaying positional information for a fifth cargo zone 165. Compared to the FIG. 10 view, a fourth cargo zone 164 and fifth cargo zone 165 have been generated via add cargo zone button 136 and dragged from off-aircraft zone 134 to interior layout 120. FIG. 12 shows an exemplary mission page 180 and an exemplary passenger weight passenger weight page 190 via select aircraft button 106. As depicted in FIG. 12, mission page 180 and passenger weight page 190 may be displayed simultaneously on user interface 100; alternatively, mission page 180 and passenger weight page 190 may be separately displayed and the user is able to navigate between the pages.

Mission page 180 provides fields for entering mission information, such as a flight date field 181, a flight number field 182, a departure location field 183, a destination location field 184, and a single pilot checkbox 185 for whether a single pilot flight is planned. Departure location field 183 and destination location field 184 may include searchable fields in which a lookup table is searched. Weight information may be displayed including an amount of useable fuel 187 and a zero-fuel weight 186 of the aircraft. Previously established missions may be imported via an import button 188 on mission page 180 (e.g., via AirDrop, email, or by selecting a file on the device of user interface 100). Additionally, a mission may be exported via an export button 189 to share data entered in mission page 180 with another device.

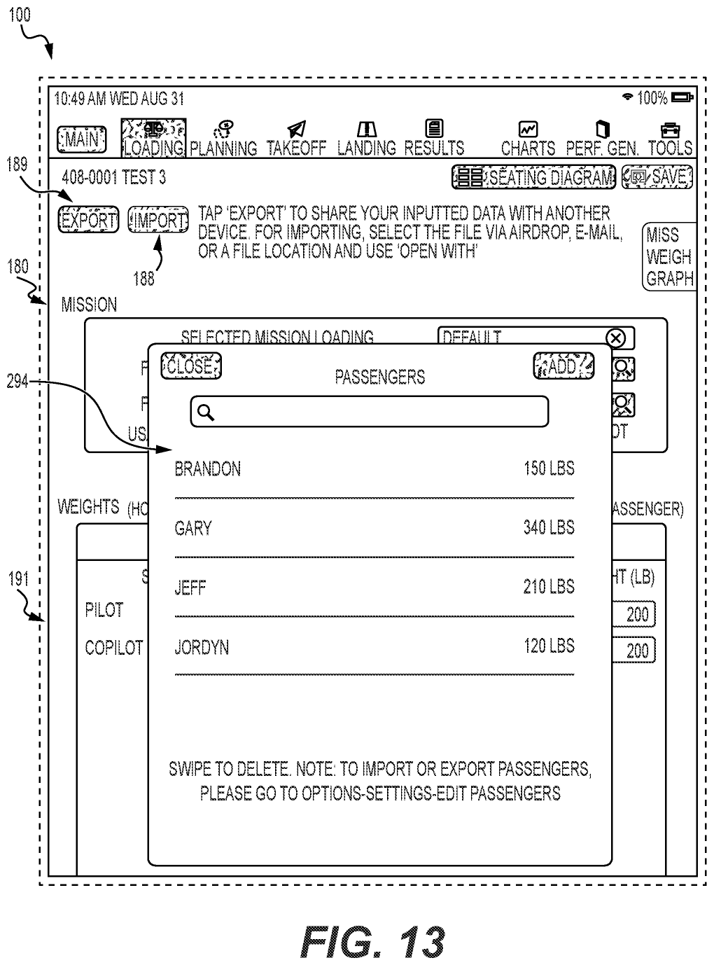

Passenger weight page 190 provides fields for entering weight information of passengers (e.g., in pounds). As depicted in the FIG. 12 embodiment, seat assignments 192 may be assigned to each passenger and passenger fields 194 may be provided for entering the passenger's name. In embodiments, each passenger field 194 comprises a selectable drop-down menu (e.g., from the “+” button), as shown in FIG. 13, with previously entered passenger names for convenience. A weight field 196 is displayed in association with each passenger name for entering passenger weight. An arm length for the longitudinal position of each seat may be listed (e.g., in inches from the aircraft datum) based on the location of the seat as established via configuration page 132 described above in connection with FIGS. 2 and 4-11, for example.

FIG. 13 shows an exemplary previous passenger list 294 of user interface 100. Passenger names and weights may be stored in memory and called up via the “+” button next to each passenger name. Selecting a name from the list then automatically populates passenger fields 194 and weight field 196 of FIG. 12.

Returning to FIG. 12, a total passenger weight value 198 may be automatically calculated and displayed as the passenger weights are entered in passenger weight page 190. To help balance the center-of-gravity of the aircraft, passengers may be assigned seats according to their weight and the arm length of the seat. A stores weight value 199 may also be displayed on passenger weight page 190 for reference. Stores may include supplies, such as refreshments, or passenger luggage stored in the aircraft cabin, and cargo is also included on the stores page.

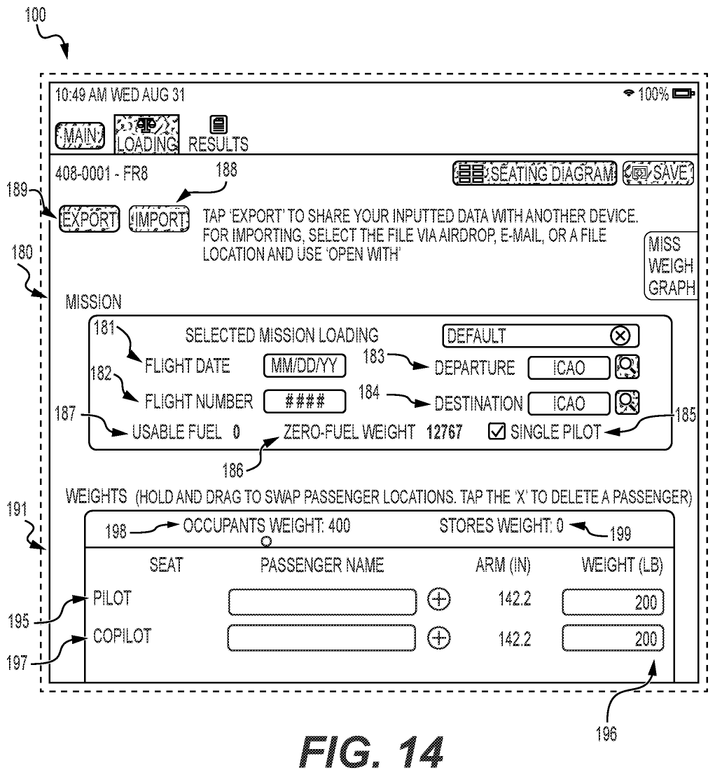

FIG. 14 shows mission page 180 and a pilot weight page 191 of user interface 100. Pilot weight page 191 is an example of passenger weight page 190 of FIG. 12 configured for inputting pilot and co-pilot weights. A pilot field 195 and a copilot field 197 may be provided for entering the pilot and copilot names. In embodiments, pilot field 195 and copilot field 197 each comprise a selectable drop-down menu from the “+” button with previously entered pilot and copilot names for convenience (see e.g., FIG. 13).

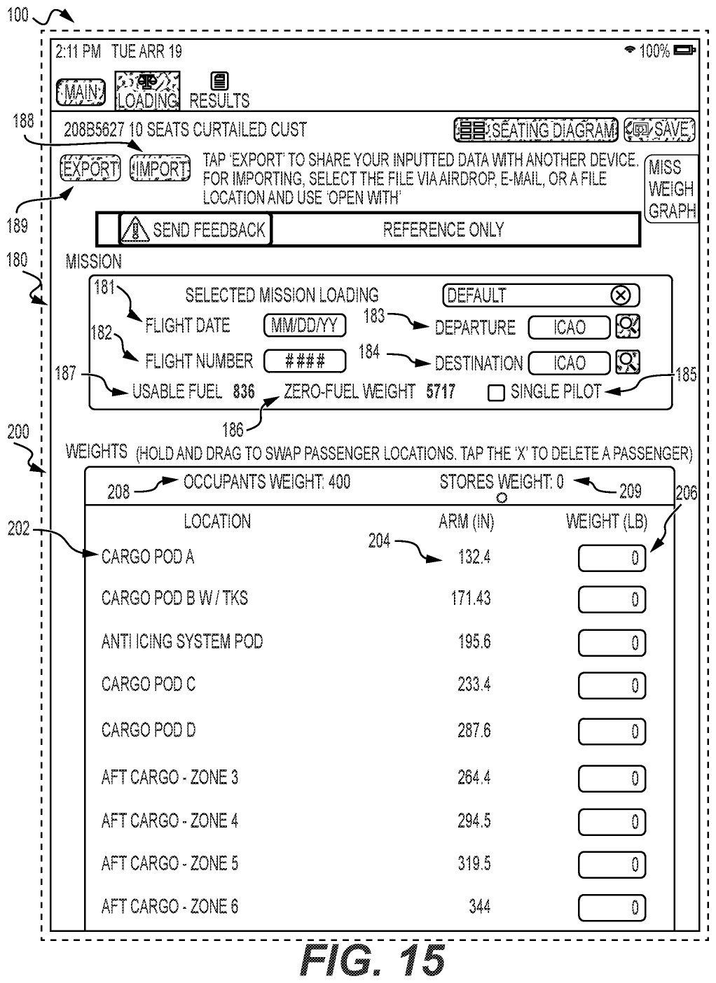

FIG. 15 shows mission page 180 and an embodiment of a cargo weight page 200 of user interface 100. In the FIG. 15 embodiment, interior layout 120 of configuration page 132 is configured for shipping cargo, and the weight information of cargo weight page 200 is directed to cargo weight accordingly. Cargo weight page 200 provides fields for entering cargo weight information (e.g., in pounds). As depicted in the FIG. 15 embodiment, cargo assignments 202 may be listed for different locations of cargo. A weight field 206 is displayed in association with each cargo item for entering the cargo's weight. An arm length 204 displays the longitudinal position of each cargo location (e.g., in inches from the aircraft datum) based on interior layout 120 established via configuration page 132 described above in connection with FIGS. 2 and 4-11, for example. To help balance the center-of-gravity of the aircraft, cargo positions may be rearranged via configuration page 132 according to their weight and the arm length of the longitudinal position. A total stores weight value 209 may be automatically calculated and displayed as the cargo/stores weights are entered in cargo weight page 200. A total passenger weight 208 is also displayed and updated as passenger and pilot/copilot weights are entered via passenger weight page 190 and pilot weight page 191.

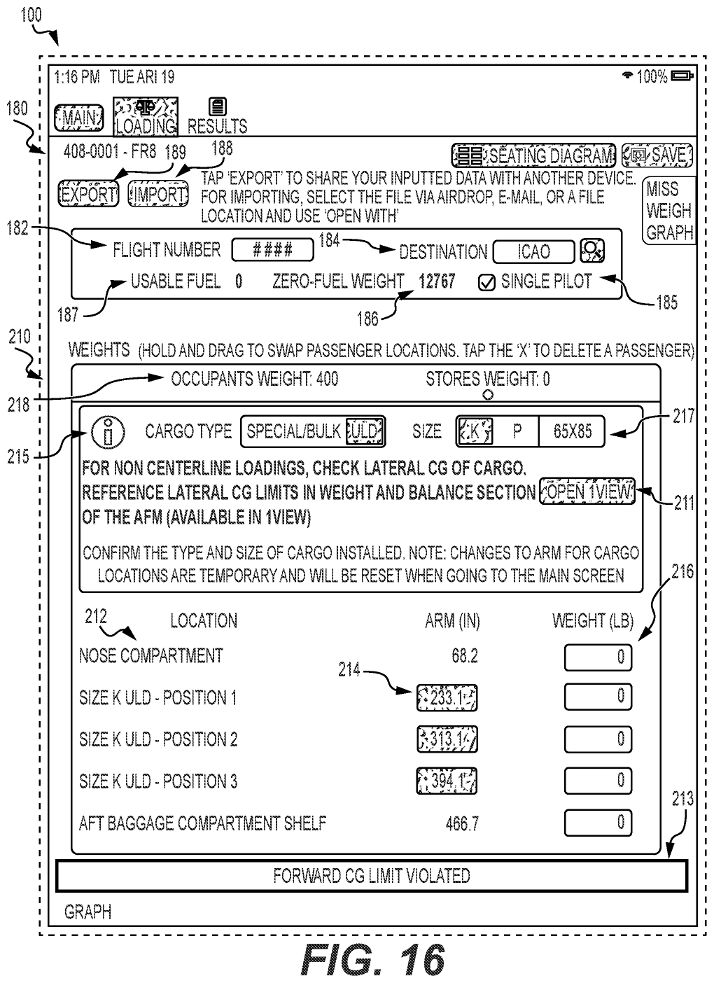

FIG. 16 shows mission page 180 and a Unit Load Device (ULD) weight page 210 of user interface 100. In the FIG. 16 embodiment, configuration page 132 is used to configure interior layout 120 for shipping ULD loadings. Alternatively, ULD weight page 210 is used to enter locations of ULD and special/bulk cargo loadings. Cargo assignments 212 may be listed for different locations of a particular type of cargo. Example types of cargo include special or bulk cargo or ULD loadings. ULD weight page 210 provides fields for entering ULD weight information (e.g., in pounds). For example, a weight field 216 is displayed in association with each cargo item for entering the cargo's weight. An arm length field 214 displays the longitudinal position of each cargo location (e.g., in inches from the aircraft datum). Arm length field 214 may be editable for providing an arm length, in embodiments. When entering arm length information into arm length field 214, a separate window may open for entering the arm lengths. Additional information may be displayed in the separate window such as a minimum and maximum arm length for each loading position.

To help balance the center-of-gravity of the aircraft, cargo positions may be rearranged via weight page 210 according to their weight and the arm length of the longitudinal position. A total payload weight value 218, which includes a running total of both occupant and cargo weights, may be automatically calculated and displayed as the weights are entered into each weight field 216. A cargo type field 215 may be provided for selecting a type of cargo (e.g., special/bulk or ULD). A size field 217 may be provided for selecting or entering size dimensions (e.g., length, width, height) of the cargo. For example, the ULD sizes may come in two or more predetermined sizes that are selectable. A warning indicator 213 may be displayed when a weight or center-of-gravity limit has been exceeded as determined by the controller based on the inputs entered through user interface 100. An open 1View button 211 provides a link to an aircraft flight manual (AFM) for referencing lateral center-of-gravity limits in a weight and balance section of the AFM, for example, as well as guidance on how to strap down certain cargo.

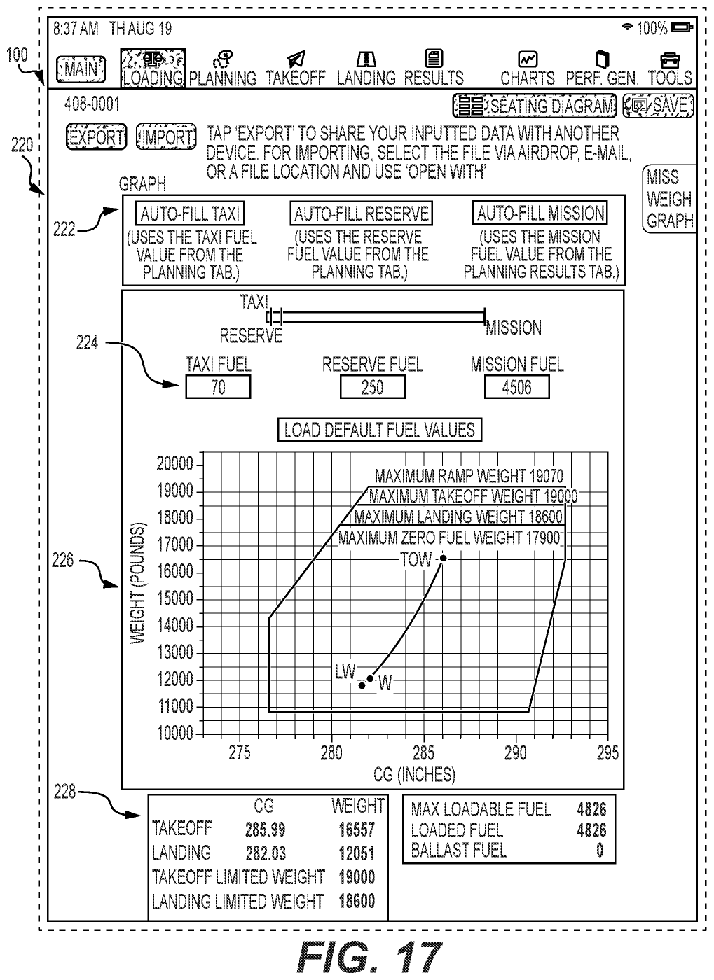

FIG. 17 shows a graph page 220 of user interface 100 for displaying information in a graph format. Graph page 220 has auto-fill buttons 222 for automatically calculating and selecting fuel amounts based on mission planning. Fuel displays 224 show numeric values for various amounts of fuel. Graph 226 shows a plot of weight versus center-of-gravity for different phases of flight. For example, a takeoff weight (TOW) is the weight of the aircraft including fuel at takeoff. The center-of-gravity of the aircraft shifts (e.g., forward) as fuel is consumed during flight and a landing weight (LW) is lower than the takeoff weight due to fuel burn. Other aircraft weights corresponding to different configurations and phases of flight may also be displayed via graph 226 without departing from the scope hereof. A text box 228 may also display numerical values for weight and center-of-gravity.

Many different arrangements of the various components depicted and components not shown are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims.

1. An aircraft weight and balance system, comprising:
a controller having a memory for storing software and a processor for executing instructions of the software;
a user interface communicatively coupled with the controller, the user interface comprising:
a configuration page that displays an interior layout of an aircraft, the interior layout having a plurality of seat icons corresponding to a plurality of seats onboard the aircraft,
wherein the user interface is configured to enable a user to move each of the seat icons to different locations within the interior layout; and
the controller is configured to automatically determine an updated weight and center-of-gravity of the aircraft based on the different locations of the seat icons.

2. The aircraft weight and balance system of claim 1,
wherein the interior layout displays a plurality of cargo icons and the user interface is configured to enable the user to move each of the cargo icons to different cargo-loading zones within the interior layout; and
the controller is configured to automatically determine an updated weight and center-of-gravity of the aircraft based on the different locations of the cargo icons.

3. The aircraft weight and balance system of claim 1 wherein the seat icons comprise at least one individual seat icon representing a seat configured for seating an individual and at least one bench seat icon representing a bench seat configured for seating two individuals.

4. The aircraft weight and balance system of claim 1 wherein each of the seat icons is configured as a selectable button for selecting by a user, and upon selection of a seat icon by the user, a move item window is opened displaying information about a selected seat.

5. The aircraft weight and balance system of claim 4 wherein the move item window comprises a move forward icon configured to enable the user to move a seat icon forwards on the interior layout, and a move aft icon configured to enable the user to move a seat icon aft on the interior layout.

6. The aircraft weight and balance system of claim 4 wherein the move item window comprises a seat position indicator that displays a seat position in the aircraft corresponding to a seat icon position in the interior layout.

7. The aircraft weight and balance system of claim 4 wherein the move item window comprises a seat center-of-gravity indicator that displays a center-of-gravity position of the seat corresponding to a position of the seat icon in the interior layout.

8. The aircraft weight and balance system of claim 4 wherein the move item window comprises a passenger center-of-gravity indicator that displays a center-of-gravity position of the passenger assigned to the selected seat.

9. The aircraft weight and balance system of claim 4 wherein the move item window comprises a directional switch that displays forward and aft options for a direction in which the seat is facing, and wherein the directional switch is selectable for switching a seat icon between forward facing and aft facing and the directional switch highlights a presently selected direction.

10. The aircraft weight and balance system of claim 9 wherein a seat center-of-gravity indicator and a passenger center-of-gravity indicator automatically update corresponding center-of-gravity information when a seat icon direction is switched between forward facing and aft facing.

11. The aircraft weight and balance system of claim 1 comprising a headrest indicator that displays an indication on a seat icon as to whether the corresponding seat includes a headrest, and wherein the headrest indicator is selectable for changing whether the seat icon includes a headrest.

12. The aircraft weight and balance system of claim 2 comprising an off-aircraft zone adjacent to the interior layout, wherein the off-aircraft zone provides a temporary location for storing seat and cargo icons while rearranging the interior layout.

13. The aircraft weight and balance system of claim 2 comprising a plurality of rail icons displayed longitudinally along the interior layout, wherein the seat icons and the cargo icons are moveable along the rail icons, and rail icons correspond with rails mounted to a floor of the aircraft upon which seat and cargo-loading zones are secured.

14. An aircraft weight and balance method, comprising:
displaying an interior layout of an aircraft on a user interface communicatively coupled with a controller, wherein the interior layout comprises a plurality of seat icons corresponding to a plurality of seats onboard an aircraft;
moving one or more of the seat icons to a different location within the interior layout based on a user input;
determining, automatically via the controller, an updated aircraft weight and an updated aircraft center-of-gravity based on a current location of the seat icons; and
displaying the updated aircraft weight and the updated aircraft center-of-gravity on the user interface.

15. The aircraft weight and balance method of claim 14 wherein the user input comprises dragging a seat icon to different location within the interior layout.

16. The aircraft weight and balance method of claim 14 wherein the user input comprises selecting a move item button to move a seat icon within the interior layout.

17. The aircraft weight and balance method of claim 14 comprising displaying a position of a seat center-of-gravity within the aircraft based on a position of a corresponding seat icon in the interior layout.

18. The aircraft weight and balance method of claim 14 comprising:
displaying a directional switch on the user interface that displays forward and aft options for a direction in which the seat is facing;
receiving a selection via the directional switch for switching a seat icon between forward facing and aft facing;
highlighting the directional switch to indicate a presently selected direction; and
updating the seat center-of-gravity when the seat icon is switched between forward facing and aft facing.

19. The aircraft weight and balance method of claim 14 comprising:
displaying a headrest indicator on the user interface that displays an indication on a seat icon as to whether the corresponding seat includes a headrest; and
receiving a selection via the headrest indicator for changing the indication on the seat icon.

20. The aircraft weight and balance method of claim 14 comprising:
displaying on the interior layout a plurality of cargo zone icons corresponding to a plurality of cargo-loading zones onboard the aircraft;
moving one or more of the cargo zone icons to a different location within the interior layout based on user input;
determining, automatically via the controller, an updated aircraft weight and an updated aircraft center-of-gravity based on a current location of the cargo zone icons; and
displaying the updated aircraft weight and the updated aircraft center-of-gravity on the user interface.
